(19) United States
(12) Patent Application Publication
(10) Pub. No.: US 2025/0277761 A1
(43) Pub. Date: Sep. 4, 2025

(54) FOREIGN MATTER INSPECTION DEVICE AND FOREIGN MATTER INSPECTION METHOD

(71) Applicant: ANRITSU CORPORATION, Kanagawa (JP)

(72) Inventor: Akira OHASHI, Kanagawa (JP)

(21) Appl. No.: 19/061,272

(22) Filed: Feb. 24, 2025

(30) Foreign Application Priority Data
Mar. 1, 2024 (JP) 2024-031369

(51) Int. Cl. G01N 23/18; G01N 9/24; G01N 23/04; G01N 23/083; G06T 7/00; G06V 10/25; G06V 10/74

(52) U.S. Cl. CPC G01N 23/18; G01N 9/24; G01N 23/04; G01N 23/083; G06T 7/0002; G06V 10/25; G06V 10/761; G01N 2223/401; G06T 2207/10116; G06T 2207/20081; G06T 2207/30108

(57) ABSTRACT

A foreign matter inspection device includes a region-of-interest setting unit that sets a region of interest including a foreign matter candidate region which is likely to include an image of a foreign matter contained in a product, a mask image generation unit that generates a mask image obtained by masking the foreign matter candidate region, a restored image generation unit that generates a restored image of a good product from the mask image based on a restoration algorithm, a difference evaluation value calculation unit that calculates a difference evaluation value for evaluating a difference between a region-of-interest image and the restored image, and a foreign matter determination unit that determines whether or not the foreign matter candidate region includes the image of the foreign matter based on a comparison between the difference evaluation value and a predetermined threshold value.

### TECHNICAL FIELD

The present invention relates to a foreign matter inspection device and a foreign matter inspection method that inspect a foreign matter in an inspection object.

### BACKGROUND ART

In the related art, as a foreign matter inspection device that detects a foreign matter, such as metal or bone, included in an inspection object, such as food, there is a foreign matter inspection device using X-rays. The X-ray foreign matter inspection device is a device that irradiates an inspection object, such as meat, fish, processed food, or a pharmaceutical product, which is sequentially transported on a transport path at predetermined intervals with X-rays and inspects whether or not a foreign matter is contained in the inspection object from the amount of irradiated X-rays transmitted through the inspection object (for example, see Patent Document 1).

In the X-ray foreign matter inspection device, a reference value, such as a foreign matter detection reference value or a determination target value, for determining whether or not the foreign matter is contained is set in advance, and a detection value detected by the device is compared with the reference value to determine whether or not the foreign matter is contained. In the case of a determination method using this reference value, there is a concern that erroneous determination will occur depending on the method for setting the reference value, and there is a demand for improvement in the accuracy of determination.

For example, when the reference value is set to a small value in order to detect the foreign matter with high sensitivity, there is a problem that erroneous detection, in which a good product is determined to be a defective product, increases. Conversely, when the reference value is set to a large value, there is a problem that erroneous detection, in which a defective product is determined to be a good product, increases.

Therefore, in the device disclosed in Patent Document 1, for a good product that is not determined to have a foreign matter based on a first reference value K₁, a measured value of the good product is compared with a second reference value K₂ set based on the measured value to determine whether or not the foreign matter is likely to be included in the inspection object, and information prompting an inspection operator to reinspect the good product determined to be likely to include the foreign matter is displayed.

### RELATED ART DOCUMENT

### [Patent Document]

[Patent Document 1] JP-A-2007-263836

### DISCLOSURE OF THE INVENTION

### Problem that the Invention is to Solve

However, the device disclosed in Patent Document 1 only determines the necessity of reinspection and has a problem in that the device does not finally determine whether the inspection object is a good product or a defective product.

The present invention has been made in order to solve the problems of the related art, and an object of the present invention is to provide a foreign matter inspection device and a foreign matter inspection method that can reduce erroneous detection of a foreign matter and inspect the foreign matter with high accuracy.

### Means for Solving the Problem

In order to solve the above-described problems, according to a first aspect of the present invention, there is provided a foreign matter inspection device that detects a foreign matter included in an inspection object based on an image. The foreign matter inspection device includes: a region-of-interest setting unit that sets a region of interest including a foreign matter candidate region, which is likely to include an image of the foreign matter in the inspection object, in an inspection image in which the foreign matter candidate region has been specified; a mask image generation unit that generates a mask image obtained by masking the foreign matter candidate region in an image of the region of interest; a restored image generation unit that generates a restored image from the mask image based on a restoration algorithm of a model obtained by learning a good product image of the inspection object; a difference evaluation value calculation unit that calculates a difference evaluation value for evaluating a difference between the image of the region of interest and the restored image; and a foreign matter determination unit that determines whether or not the foreign matter candidate region includes the image of the foreign matter based on a comparison between the difference evaluation value and a predetermined threshold value.

Therefore, the foreign matter inspection device according to the first aspect of the present invention can reduce erroneous detection of the foreign matter and inspect the foreign matter with high accuracy, as compared to a case where the determination of the foreign matter is performed using only the image of the region of interest. For example, when provisional determination is performed using only the image of the region of interest and then redetermination is performed using a difference image between the image of the region of interest and the restored image, it is possible to double-check the inspection and to improve the inspection performance.

In addition, according to a second aspect of the present invention, in the foreign matter inspection device according to the first aspect, the inspection image may be an X-ray absorption image obtained by converting an amount of X-rays transmitted through the inspection object into a density value proportional to a thickness of the inspection object, and the difference evaluation value may be a value based on a difference between density values of the image of the region of interest and the restored image. When an absolute value of a positive difference between density values is equal to an absolute value of a negative difference between density values, the difference evaluation value obtained from the positive difference between the density values may be different from the difference evaluation value obtained from the negative difference between the density values.

In the foreign matter inspection device according to the second aspect of the present invention, the difference evaluation value obtained from the positive difference between the density values is set to be larger than the difference evaluation value obtained from the negative difference between the density values having the same absolute value. Therefore, when the inspection image is the X-ray absorption image, it is possible to accurately detect the foreign matter having a positive difference between the density values of the image of the region of interest and the restored image.

Further, in the foreign matter inspection device according to the second aspect of the present invention, the difference evaluation value obtained from the positive difference between the density values is set to be smaller than the difference evaluation value obtained from the negative difference between the density values having the same absolute value. Therefore, when the inspection image is the X-ray absorption image, it is possible to accurately detect the foreign matter having a negative difference between the density values of the image of the region of interest and the restored image.

In addition, according to a third aspect of the present invention, in the foreign matter inspection device according to the first aspect, the inspection image may be an X-ray transmission image obtained by converting an amount of X-rays transmitted through the inspection object into a brightness value, and the difference evaluation value is a value based on a difference between brightness values of the image of the region of interest and the restored image. When an absolute value of a positive difference between brightness values is equal to an absolute value of a negative difference between brightness values, the difference evaluation value obtained from the negative difference between the brightness values may be different from the difference evaluation value obtained from the positive difference between the brightness values.

In the foreign matter inspection device according to the third aspect of the present invention, the difference evaluation value obtained from the negative difference between the brightness values is set to be larger than the difference evaluation value obtained from the positive difference between the brightness values having the same absolute value. Therefore, when the inspection image is the X-ray transmission image, it is possible to accurately detect the foreign matter having a negative difference between the brightness values of the image of the region of interest and the restored image.

In addition, in the foreign matter inspection device according to the third aspect of the present invention, the difference evaluation value obtained from the negative difference between the brightness values is set to be smaller than the difference evaluation value obtained from the positive difference between the brightness values having the same absolute value. Therefore, when the inspection image is the X-ray transmission image, it is possible to accurately detect the foreign matter having a positive difference between the brightness values of the image of the region of interest and the restored image.

Further, according to a fourth aspect of the present invention, the foreign matter inspection device according to the first aspect may further include a foreign matter candidate region specification unit that specifies the foreign matter candidate region in the inspection image. Furthermore, according to a fifth aspect of the present invention, the foreign matter inspection device according to the second aspect may further include a foreign matter candidate region specification unit that specifies the foreign matter candidate region in the inspection image. Moreover, according to a sixth aspect of the present invention, the foreign matter inspection device according to the third aspect may further include a foreign matter candidate region specification unit that specifies the foreign matter candidate region in the inspection image.

In addition, according to a seventh aspect of the present invention, there is provided a foreign matter inspection method for detecting a foreign matter included in an inspection object based on an image. The foreign matter inspection method includes: a region-of-interest setting step of setting a region of interest including a foreign matter candidate region, which is likely to include an image of the foreign matter in the inspection object, in an inspection image in which the foreign matter candidate region has been specified; a mask image generation step of generating a mask image obtained by masking the foreign matter candidate region in an image of the region of interest; a restored image generation step of generating a restored image from the mask image based on a restoration algorithm of a model obtained by learning a good product image of the inspection object; a difference evaluation value calculation step of calculating a difference evaluation value for evaluating a difference between the image of the region of interest and the restored image; and a foreign matter determination step of determining whether or not the foreign matter candidate region includes the image of the foreign matter based on a comparison between the difference evaluation value and a predetermined threshold value.

### Advantage of the Invention

Therefore, the foreign matter inspection method according to the seventh aspect of the present invention can reduce erroneous detection of the foreign matter and inspect the foreign matter with high accuracy, as compared to a case where the determination of the foreign matter is performed using only the image of the region of interest.

In addition, according to an eighth aspect of the present invention, in the foreign matter inspection method according to the seventh aspect, the inspection image may be an X-ray absorption image obtained by converting an amount of X-rays transmitted through the inspection object into a density value proportional to a thickness of the inspection object, and the difference evaluation value may be a value based on a difference between density values of the image of the region of interest and the restored image. When an absolute value of a positive difference between density values is equal to an absolute value of a negative difference between density values, the difference evaluation value obtained from the positive difference between the density values may be different from the difference evaluation value obtained from the negative difference between the density values.

Further, according to a ninth aspect of the present invention, in the foreign matter inspection method according to the seventh aspect, the inspection image may be an X-ray transmission image obtained by converting an amount of X-rays transmitted through the inspection object into a brightness value, and the difference evaluation value may be a value based on a difference between brightness values of the image of the region of interest and the restored image. When an absolute value of a positive difference between brightness values is equal to an absolute value of a negative difference between brightness values, the difference evaluation value obtained from the negative difference between the brightness values may be different from the difference evaluation value obtained from the positive difference between the brightness values.

Furthermore, according to a tenth aspect of the present invention, the foreign matter inspection method according to the seventh aspect may further include a foreign matter candidate region specification step of specifying the foreign matter candidate region in the inspection image.

### BRIEF DESCRIPTION OF THE DRAWINGS

FIG. 1 is a schematic diagram showing a configuration of a foreign matter inspection device according to an embodiment of the present invention.

FIG. 2 is a diagram showing a region of an inspection image handled by the foreign matter inspection device shown in FIG. 1.

FIG. 3 is a diagram showing a process of the foreign matter inspection device shown in FIG. 1.

FIGS. 4A to 4D are graphs showing a relationship between a difference evaluation value calculated by a difference evaluation value calculation unit provided in the foreign matter inspection device shown in FIG. 1 and a difference between brightness values or density values of a region-of-interest image and a restored image, FIG. 4A shows an example in which the difference evaluation value is symmetrical with respect to the positive and negative values of the difference between the brightness values or the density values, FIGS. 4B and 4C show an example in which the difference evaluation value is asymmetrical with respect to the positive and negative values of the difference between the brightness values or the density values, and FIG. 4D shows an example in which the difference evaluation value is equal to the difference between the brightness values or the density values.

FIG. 5 is a flowchart showing a process of a foreign matter inspection method using the foreign matter inspection device shown in FIG. 1.

### BEST MODE FOR CARRYING OUT THE INVENTION

Hereinafter, an embodiment of a foreign matter inspection device and a foreign matter inspection method according to the present invention will be described with reference to the drawings.

A foreign matter inspection device 1 is installed in a portion of a transport line for transporting an inspection object 100 and detects the presence or absence of a foreign matter, such as metal, glass, stone, or bone, contained in the inspection object 100 that is sequentially transported at a predetermined interval. Examples of the foreign matter inspection device 1 include an X-ray inspection device using X-rays and an inspection device that irradiates the inspection object 100 with light in a near-infrared region or a visible light region and measures transmitted light or reflected light. In the present embodiment, a case where the foreign matter inspection device 1 is the X-ray inspection device will be described as an example.

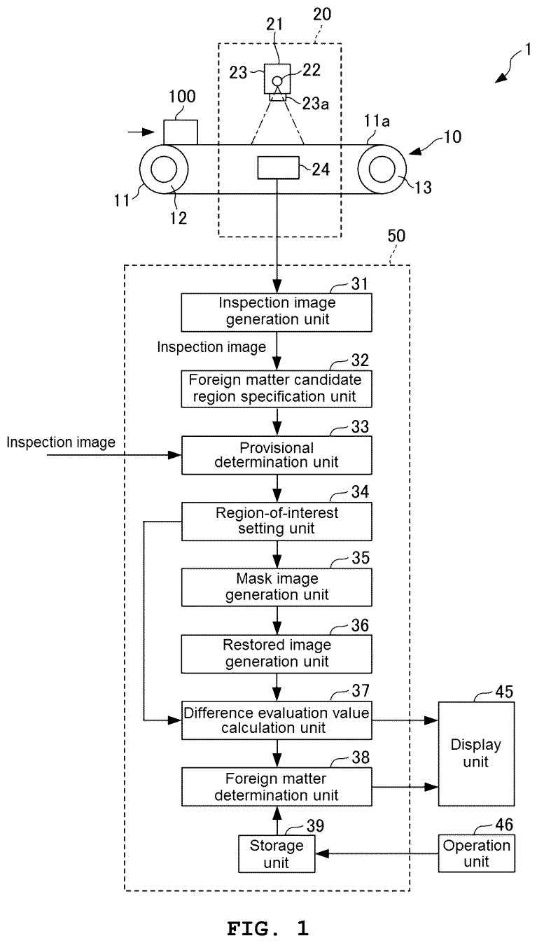

As shown in FIG. 1, the foreign matter inspection device 1 includes a transport unit 10, an X-ray inspection unit 20, and a control unit 50 including a display unit 45 and an operation unit 46.

The transport unit 10 is a conveyor in which a loop-shaped transport belt 11 is wound around a plurality of transport rollers 12 and 13 and is supported by a housing (not shown). The transport unit 10 can sequentially transport the inspection object 100 placed on a transport surface 11a of the transport belt 11 in the right direction in FIG. 1 such that the inspection object 100 passes through a predetermined inspection section of the X-ray inspection unit 20. The placement of the inspection object 100 on the transport belt 11 may be manually performed by a user or may be performed by a dedicated device (not shown).

The transport belt 11 is made of a material (an element other than an element with a large atomic mass) that easily transmits X-rays. The transport belt 11 is driven by controlling the rotation of a driving motor such that the transport belt 11 is moved at a transport speed set in advance by the operation unit 46 when the inspection object 100 is inspected. As a result, the inspection object 100 carried in from a carry-in port is transported to a carry-out port in the right direction of FIG. 1 at the set transport speed.

The X-ray inspection unit 20 includes an X-ray source 21 that irradiates the inspection object 100 transported by the transport unit 10 with the X-rays in a predetermined energy band transmitted through the inspection object 100. The X-ray source 21 can generate the X-rays with a wavelength and intensity corresponding to a tube current and a tube voltage of a known X-ray tube 22 using the X-ray tube 22 and irradiate the inspection object 100 on the transport belt 11 with fan-beam X-rays in a direction orthogonal to a transport direction of the transport unit 10 through an X-ray window portion 23a of an envelope 23.

The X-ray inspection unit 20 further includes an X-ray detector 24 that is disposed directly below the transport belt 11.

The X-ray detector 24 is configured by an X-ray line sensor camera in which detection elements, each of which includes a scintillator as a phosphor and a photodiode or a charge-coupled device, are disposed in an array at a predetermined pitch in a width direction of a transport path of the transport unit 10 to detect the X-rays at a predetermined resolution, which is not shown.

That is, the X-ray detector 24 can detect the X-rays, which have been emitted from the X-ray source 21 and transmitted through the inspection object 100, for each predetermined transmission region of the inspection object 100 corresponding to the detection element, convert the detected X-rays into an electric signal corresponding to a transmission amount of the detected X-rays, and output an X-ray detection signal for each transmission region.

The control unit 50 controls the transport speed, transport interval, and the like of the inspection object 100 by the transport belt 11 in the transport unit 10. Further, the control unit 50 controls the X-ray irradiation intensity and irradiation period of the X-ray inspection unit 20 or controls the X-ray detection period of the X-ray line sensor of the X-ray detector 24, the detection period of the inspection object 100, and the like according to the transport speed of the inspection object 100.

In addition, the control unit 50 includes an inspection image generation unit 31, a foreign matter candidate region specification unit 32, a provisional determination unit 33, a region-of-interest setting unit 34, a mask image generation unit 35, a restored image generation unit 36, a difference evaluation value calculation unit 37, a foreign matter determination unit 38, and a storage unit 39.

The inspection image generation unit 31 receives the X-ray detection signal from the X-ray detector 24 at each predetermined period and generates an inspection image of the inspection object 100 which consists of information of a two-dimensional position determined by the passing direction of the inspection object 100 and the arrangement direction of the detection elements and a result of signal processing at each position.

In addition, the inspection image generated by the inspection image generation unit 31 may be an X-ray transmission image obtained by converting the amount of X-rays transmitted through the inspection object 100 into a brightness value or may be an X-ray absorption image obtained by converting the amount of X-rays transmitted through the inspection object 100 into a density value proportional to the thickness of the inspection object 100. The inspection image generation unit 31 generates the inspection image each time the inspection object 100 is transported to the X-ray inspection unit 20 and passes through a predetermined inspection section.

For the X-ray absorption image, for example, when an X-ray absorption rate of the inspection object 100 is a and the thickness of the inspection object 100 is L, intensity S′ after the X-ray with intensity S is transmitted through the inspection object 100 can be theoretically written as S′=S·exp(−α·L). When the logarithm of both sides is taken and the expression is transformed, the expression can also be written as α·L=log(S)−log(S′). The X-ray transmission image corresponds to a two-dimensional distribution of S′. When the logarithm is taken and the expression is transformed as described above, it is possible to calculate the X-ray absorption image showing the two-dimensional distribution of the absorption amount a L by the inspection object 100.

Alternatively, the inspection image generated by the inspection image generation unit 31 may be a transmission image or a reflection image of the inspection object 100 captured by the imaging device in a state in which the inspection object 100 is irradiated with light in the near-infrared region or the visible light region.

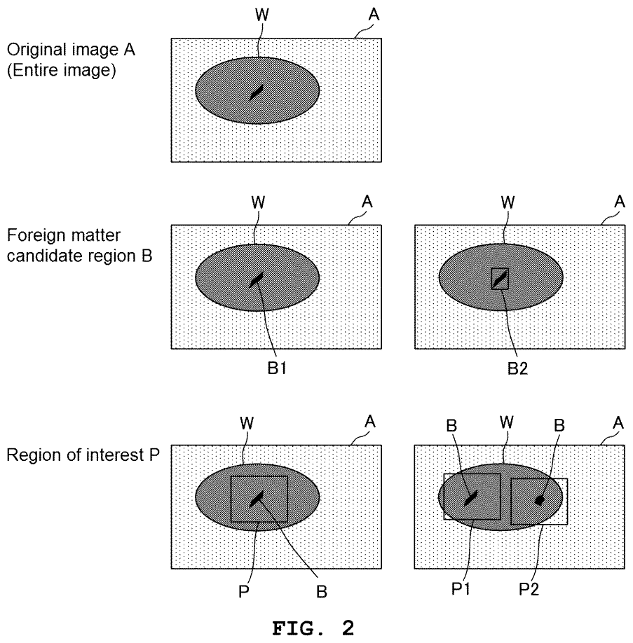

FIG. 2 is a diagram showing each region of the inspection image including an image W of the inspection object 100.

An original image A is an image including the image W of the inspection object 100 among the inspection images generated by the inspection image generation unit 31. Further, hereinafter, the original image A of the inspection image is also simply referred to as an “inspection image A”.

A foreign matter candidate region B is defined as a region B1 that is likely to include an image of a foreign matter in the inspection object 100, a rectangular region B2 including the region B1, or the like in the original image A.

A region of interest P is a region including the foreign matter candidate region B in the original image A. When there are a plurality of foreign matter candidate regions B in the original image A, the region of interest P is set for each of the plurality of foreign matter candidate regions B. FIG. 2 shows an example in which one region of interest P is set for one foreign matter candidate region B and an example in which two regions of interest P1 and P2 are set for two foreign matter candidate regions B, respectively. In addition, the region of interest P may be the entire region of the original image A. Further, hereinafter, the image of the region of interest P is also referred to as a “region-of-interest image P”.

The foreign matter candidate region specification unit 32 specifies the foreign matter candidate region B that is likely to include the image of the foreign matter in the inspection object 100 in the inspection image A generated by the inspection image generation unit 31. The specification of the foreign matter candidate region B by the foreign matter candidate region specification unit 32 is performed by various known foreign matter inspection algorithms.

For example, the foreign matter candidate region specification unit 32 may execute image processing, such as filtering for extracting the image of the foreign matter, on the inspection image A generated by the inspection image generation unit 31 to specify the region of the image of the foreign matter contained in the inspection object 100. For example, a feature extraction filter, such as a differential filter (a Roberts filter, a Prewitt filter, or a Sobel filter) or a Laplacian filter, is used as a filter for enhancing the image of the foreign matter.

Alternatively, the foreign matter candidate region specification unit 32 may specify the foreign matter candidate region B in the inspection image A using a deep learning-based object detection model such as a single shot multibox detector (SSD) or you only look once (YOLO).

The provisional determination unit 33 compares the brightness value or density value of the foreign matter candidate region B specified by the foreign matter candidate region specification unit 32 with a predetermined threshold value to provisionally determine whether or not the image of the foreign matter is included in the foreign matter candidate region B. In addition, the inspection image A provisionally determined to include the foreign matter candidate region B by the provisional determination unit 33 may be an image in which the foreign matter candidate region B has been specified by any external device.

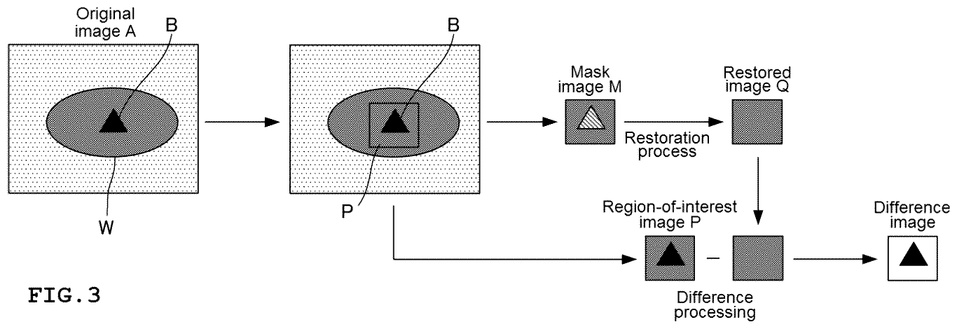

As schematically shown in FIG. 3, the region-of-interest setting unit 34 sets the region of interest P including the foreign matter candidate region B in the original image A of the inspection image in which the foreign matter candidate region B has been specified. The setting of the region of interest P by the region-of-interest setting unit 34 may be performed on all of the inspection images A or may be performed only on the inspection image A provisionally determined to include the image of the foreign matter by the provisional determination unit 33. In addition, when the foreign matter candidate region specification unit 32 specifies a plurality of foreign matter candidate regions B in one inspection image A, the region-of-interest setting unit 34 sets a plurality of regions of interest P respectively including the plurality of foreign matter candidate regions B in the inspection image A.

As schematically shown in FIG. 3, the mask image generation unit 35 generates a mask image M subjected to masking the foreign matter candidate region B in the region-of-interest image P set by the region-of-interest setting unit 34. For example, the mask image generation unit 35 generates, as the mask image M, an image obtained by filling the foreign matter candidate region B in the region-of-interest image P with a constant value of, typically, 0 or by removing the foreign matter candidate region B.

The restored image generation unit 36 performs a restoration process of generating a restored image Q from the mask image M based on a restoration algorithm of a model obtained by learning a good product image, which is an image of a good product of the inspection object 100, as schematically shown in FIG. 3. Here, the good product image is, for example, an image of a good product that is the same type as the inspection object 100 and does not include the foreign matter.

The restoration algorithm used by the restored image generation unit 36 to generate the restored image Q is, for example, an algorithm using deep learning or an algorithm using K-singular value decomposition (K-SVD).

The learning of the restored image generation unit 36 is performed using a plurality of good product images subjected to any masking. In this case, it is desirable that the good product image does not include image information, such as a background of the good product, other than the good product.

That is, the restoration algorithm of the restored image generation unit 36 can learn the good product image that does not include the foreign matter to convert the mask image M into the restored image Q that does not include the foreign matter.

The difference evaluation value calculation unit 37 calculates a difference evaluation value for evaluating a difference between the region-of-interest image P and the restored image Q generated by the restored image generation unit 36.

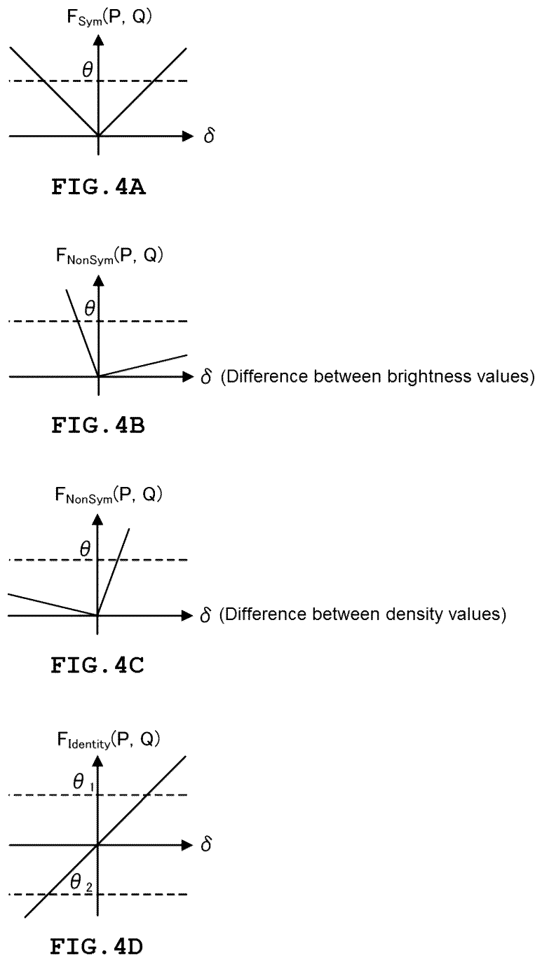

For example, the difference evaluation value calculation unit 37 calculates, as the difference evaluation value, an absolute value F_{Sym}(P, Q) of a difference δ between the brightness values or density values of the region-of-interest image P and the restored image Q according to the following Expressions (1a), (1b), and (2). FIG. 4A is a graph showing a difference evaluation value F_{Sym}(P, Q) that is symmetric with respect to the positive and negative values of the difference δ between the brightness values or density values of the region-of-interest image P and the restored image Q.

$$\begin{matrix}[ Equation 1 ] & \\ {i}^{*} , {j}^{*} = arg {max}_{i , j} \vert {P}_{i , j} - {Q}_{i , j} \vert & ( 1 a )\end{matrix}$$

$$δ = {P}_{{i}^{*} , {j}^{*}} - {Q}_{{i}^{*} , {j}^{*}} \qquad ( 1 b )$$

$$\begin{matrix}[ Equation 2 ] & \\ {F}_{Sym} ( P , Q ) = \vert δ \vert & ( 2 )\end{matrix}$$

Expression (1a) indicates pixels (i*, j*) of which the absolute value of the difference δ between the brightness values or density values is the maximum value among the pixels at the same positions in the region-of-interest image P and the restored image Q. δ of Expression (1b) indicates the difference between the brightness values or density values of the region-of-interest image P and the restored image Q in the pixels (i*, j*).

That is, as schematically shown in FIG. 3, the difference evaluation value calculation unit 37 performs difference processing of generating a difference image that consists of the difference δ between the brightness values or density values of the region-of-interest image P and the restored image Q. The difference image generated by the difference evaluation value calculation unit 37 may be displayed on the display unit 45.

Alternatively, the difference evaluation value calculation unit 37 may calculate, as the difference evaluation value, F_{NonSym}(P, Q) that is asymmetric with respect to the positive and negative values of the difference δ between the brightness values or density values of the region-of-interest image P and the restored image Q according to the following Expression (3).

$$\begin{matrix}[ Equation 3 ] & \\ {F}_{NonSym} ( P , Q ) = {w}_{1} δ + {w}_{2} \vert δ \vert & ( 3 )\end{matrix}$$

FIG. 4B is a graph showing a difference evaluation value F_{NonSym}(P, Q) when δ is the difference between the brightness values of the region-of-interest image P and the restored image Q in the pixels (i*, j*). Here, w₁+w₂>0, w₁<w₂, and w₁<0 are satisfied. That is, the absolute value of the slope of the difference evaluation value F_{NonSym}(P, Q) with respect to the negative difference δ between the brightness values is larger than the absolute value of the slope of the difference evaluation value F_{NonSym}(P, Q) with respect to the positive difference δ between the brightness values.

That is, for F_{NonSym}(P, Q) satisfying w₁+w₂>0, w₁<w₂, and w₁<0, when the absolute value of the positive difference δ between the brightness values is equal to the absolute value of the negative difference δ between the brightness values, the difference evaluation value F_{NonSym}(P, Q) obtained from the negative difference δ between the brightness values is larger than the difference evaluation value F_{NonSym}(P, Q) obtained from the positive difference δ between the brightness values. In the X-ray transmission image, the brightness value of the foreign matter is often smaller than that of other normal portions. Therefore, when F_{NonSym}(P, Q) is used as the difference evaluation value shown in FIG. 4B, it is possible to improve the accuracy of determining the foreign matter in the foreign matter determination unit 38 in the subsequent stage.

FIG. 4C is a graph showing the difference evaluation value F_{NonSym}(P, Q) when δ is the difference between the density values of the region-of-interest image P and the restored image Q in the pixels (i*, j*). Here, w₁+w₂>0, w₁<w₂, and w₁>0 are satisfied. That is, the absolute value of the slope of the difference evaluation value F_{NonSym}(P, Q) with respect to the positive difference δ between the density values is larger than the absolute value of the slope of the difference evaluation value F_{NonSym}(P, Q) with respect to the negative difference δ between the density values.

That is, for F_{NonSym}(P, Q) in which w₁+w₂>0, w₁<w₂, and w₁>0 are satisfied, when the absolute value of the positive difference δ between the density values is equal to the absolute value of the negative difference δ between the density values, the difference evaluation value F_{NonSym}(P, Q) obtained from the positive difference δ between the density values is larger than the difference evaluation value F_{NonSym}(P, Q) obtained from the negative difference δ between the density values. In the X-ray absorption image, the density value of the foreign matter is often larger than that of other normal portions. Therefore, when F_{NonSym}(P, Q) is used as the difference evaluation value shown in FIG. 4C, it is possible to improve the accuracy of determining the foreign matter in the foreign matter determination unit 38 in the subsequent stage.

As described above, the graphs of FIGS. 4B and 4C show the difference evaluation values F_{NonSym}(P, Q) suitable for a case where the brightness value of the foreign matter is smaller than that of other normal portions in the X-ray transmission image and a case where the density value of the foreign matter is larger than that of other normal portions in the X-ray absorption image, respectively.

However, for example, when the user wants detect a cavity in the inspection object 100 as the foreign matter, conversely, the brightness value of the cavity is larger than that of other normal portions in the X-ray transmission image, and the density value of the cavity is smaller than that of other normal portions in the X-ray absorption image.

In this case, for the X-ray transmission image, when the absolute value of the positive difference δ between the brightness values is equal to the absolute value of the negative difference δ between the brightness values, the difference evaluation value F_{NonSym}(P, Q) at which the difference evaluation value F_{NonSym}(P, Q) obtained from the negative difference δ between the brightness values is smaller than the difference evaluation value F_{NonSym}(P, Q) obtained from the positive difference δ between the brightness values may be used. Similarly, for the X-ray absorption image, when the absolute value of the positive difference δ between the density values is equal to the absolute value of the negative difference δ between the density values, the difference evaluation value F_{NonSym}(P, Q) at which the difference evaluation value F_{NonSym}(P, Q) obtained from the positive difference δ between the density values is smaller than the difference evaluation value F_{NonSym}(P, Q) obtained from the negative difference δ between the density values and may be used.

Alternatively, the difference evaluation value calculation unit 37 may output the difference δ between the brightness values or density values of the region-of-interest image P and the restored image Q as a difference evaluation value F_{Identity}(P, Q) without any change according to the following Expression (4). FIG. 4D is a graph showing the difference evaluation value F_{Identity}(P, Q).

$$\begin{matrix}[ Equation 4 ] & \\ {F}_{Identity} ( P , Q ) = δ & ( 4 )\end{matrix}$$

Alternatively, the difference evaluation value calculation unit 37 may calculate a difference evaluation value δ_{SSIM} using a structural similarity index measure (SSIM) according to the following Expressions (5a) to (5d).

$$\begin{matrix}[ Equation 5 ] & \\ {δ}_{SSIM} = SSIM ( P , Q ) = I ( P , Q ) c ( P , Q ) s ( P , Q ) = \frac{( 2 {μ}_{P} {μ}_{Q} + {c}_{1} ) ( 2 {σ}_{PQ} + {c}_{2} )}{( {μ}_{P}^{2} + {μ}_{Q}^{2} + {c}_{1} ) ( {σ}_{P}^{2} + {σ}_{Q}^{2} + {c}_{2} )} & ( 5 a )\end{matrix}$$

$$I ( P , Q ) = \frac{2 {μ}_{P} {μ}_{Q} + {c}_{1}}{{μ}_{P}^{2} + {μ}_{Q}^{2} + {c}_{1}} \qquad ( 5 b )$$

$$c ( P , Q ) = \frac{2 {σ}_{P} {σ}_{Q} + {c}_{2}}{{σ}_{P}^{2} + {σ}_{Q}^{2} + {c}_{2}} \qquad ( 5 c )$$

$$s ( P , Q ) = \frac{2 {σ}_{PQ} + {c}_{2}}{2 {σ}_{P} {σ}_{Q} + {c}_{2}} \qquad ( 5 d )$$

In Expressions (5a) to (5d), μ_{P} is defined as an average brightness value or average density value of the region-of-interest image P, and μ_{Q} is defined as an average brightness value or average density value of the restored image Q. σ_{P} is defined as a standard deviation of the brightness values or density values of the region-of-interest image P, and σ_{Q} is defined as a standard deviation of the brightness values or density values of the restored image Q. c₁ and c₂ are defined as small constants for preventing division by zero error.

I(P, Q) indicates a rate of match between the average brightness values or average density values of the region-of-interest image P and the restored image Q and has a minimum value of 0 and a maximum value of 1. c(P, Q) indicates a rate of match between contrasts of the brightness values or density values of the region-of-interest image P and the restored image Q and has a minimum value of 0 and a maximum value of 1. s(P, Q) indicates a correlation coefficient between the brightness values or density values of the region-of-interest image P and the restored image Q and has a minimum value of −1 and a maximum value of 1. That is, the minimum value of the difference evaluation value δ_{SSIM} is −1, and the maximum value thereof is 1.

Alternatively, the difference evaluation value calculation unit 37 may calculate a similarity (distance) between distributions of the brightness values or density values of the region-of-interest image P and the restored image Q as the difference evaluation value like Kullback-Leibler divergence (KLD). Alternatively, the difference evaluation value calculation unit 37 may calculate a distance between any image feature amounts of the region-of-interest image P and the restored image Q as the difference evaluation value.

The foreign matter determination unit 38 determines whether or not the foreign matter candidate region B includes the image of the foreign matter based on the comparison between the difference evaluation value calculated by the difference evaluation value calculation unit 37 and a predetermined threshold value. A determination result of the foreign matter determination unit 38 is displayed on the display unit 45.

For example, when the difference evaluation value F_{Sym}(P, Q) or F_{NonSym}(P, Q) exceeds a predetermined threshold value θ, the foreign matter determination unit 38 determines that the foreign matter candidate region B includes the image of the foreign matter.

In addition, in a case where the inspection image A is an X-ray absorption image and the density value of the foreign matter desired to be detected is expected to be larger than that of other normal portions, when F_{Identity}(P, Q) is larger than a predetermined threshold value θ₁ (>0), the foreign matter determination unit 38 determines that the foreign matter candidate region B includes the image of the foreign matter. Meanwhile, in a case where the inspection image A is an X-ray absorption image and the density value of the foreign matter desired to be detected is expected to be smaller than that of other normal portions, when F_{Identity}(P, Q) is smaller than a predetermined threshold value θ₂ (<0), the foreign matter determination unit 38 determines that the foreign matter candidate region B includes the image of the foreign matter.

In addition, in a case where the inspection image A is an X-ray transmission image and the brightness value of the foreign matter desired to be detected is expected to be larger than that of other normal portions, when F_{Identity}(P, Q) is larger than the predetermined threshold value θ₁ (>0), the foreign matter determination unit 38 determines that the foreign matter candidate region B includes the image of the foreign matter. Meanwhile, in a case where the inspection image A is an X-ray transmission image and the brightness value of the foreign matter desired to be detected is expected to be smaller than that of other normal portions, when F_{Identity}(P, Q) is smaller than the predetermined threshold value θ₂ (<0), the foreign matter determination unit 38 determines that the foreign matter candidate region B includes the image of the foreign matter.

FIGS. 4A to 4D show a case where the threshold values θ, θ₁, and θ₂ are constant values. However, these threshold values may change depending on the magnitude of the difference δ between the brightness values or the density values.

Alternatively, the foreign matter determination unit 38 may provide a threshold value for each of various difference evaluation values, such as the difference evaluation value δ_{SSIM} by SSIM and the difference evaluation value by KLD, calculated by the difference evaluation value calculation unit 37 and may determine whether or not the foreign matter candidate region B includes the image of the foreign matter. In addition, the foreign matter determination unit 38 may determine that the foreign matter candidate region B includes the image of the foreign matter only when all of the plurality of difference evaluation values calculated by the difference evaluation value calculation unit 37 are values indicating that the foreign matter candidate region B includes the image of the foreign matter.

The storage unit 39 stores each threshold value used in the foreign matter determination unit 38. For example, each threshold value used in the foreign matter determination unit 38 is predetermined according to the type of the inspection object 100 and the type of the difference evaluation value calculated by the difference evaluation value calculation unit 37. In addition, the threshold value stored in the storage unit 39 may be changed to a desired value by the input of an operation to the operation unit 46 by the user.

Alternatively, each threshold value used in the foreign matter determination unit 38 may be automatically set based on the inspection image A. For example, the foreign matter determination unit 38 may set each threshold value based on the maximum and minimum values of the brightness value or density value of the inspection image A.

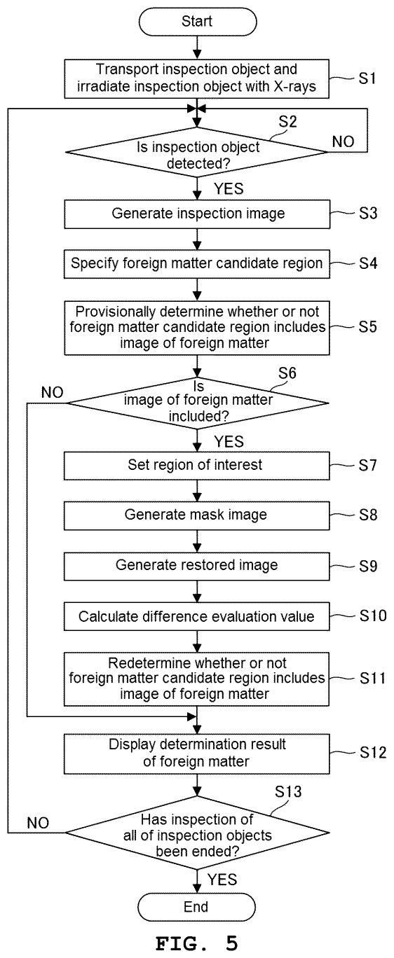

Hereinafter, an example of a process of the foreign matter inspection method using the foreign matter inspection device 1 according to the present embodiment will be described with reference to a flowchart shown in FIG. 5. In addition, a description that overlaps with the description of the configuration of the foreign matter inspection device 1 will be omitted as appropriate.

First, when the user inputs an operation of issuing a measurement start instruction using the operation unit 46, the transport unit 10 starts sequentially transporting one or more inspection objects 100 placed on the transport belt 11 by the user or the dedicated device. Then, the X-ray source 21 irradiates the inspection object 100, which is transported by the transport unit 10 and passes through a predetermined inspection section, with the X-rays (Step S1).

Then, when the detection sensor (not shown) detects the entry of the inspection object 100 into the inspection section (Step S2: YES), the inspection image generation unit 31 generates an inspection image of the inspection object 100 transported by the transport unit 10 (Step S3).

Then, the foreign matter candidate region specification unit 32 specifies the foreign matter candidate region B that is likely to include the image of the foreign matter in the inspection object 100 in the inspection image A generated by the inspection image generation unit 31 (Step S4).

Then, the provisional determination unit 33 compares the brightness value or density value of the foreign matter candidate region B specified by the foreign matter candidate region specification unit 32 with a predetermined threshold value to provisionally determines whether or not the image of the foreign matter is included in the foreign matter candidate region B (Step S5).

When the provisional determination unit 33 provisionally determines that the image of the foreign matter is included in the foreign matter candidate region B (Step S6: YES), a process in Step S7 and the subsequent steps is executed. When the provisional determination unit 33 provisionally determines that the image of the foreign matter is not included in the foreign matter candidate region B, a process in Step S12 and the subsequent steps is executed.

In Step S7, the region-of-interest setting unit 34 sets the region of interest P including the foreign matter candidate region B in the inspection image A in which the foreign matter candidate region B has been specified (region-of-interest setting step S7).

Then, the mask image generation unit 35 generates the mask image M obtained by masking the foreign matter candidate region B in the region-of-interest image P (mask image generation step S8).

Then, the restored image generation unit 36 generates the restored image Q from the mask image M based on the restoration algorithm of the model obtained by learning the good product image of the inspection object 100 (restored image generation step S9).

Then, the difference evaluation value calculation unit 37 calculates the difference evaluation value for evaluating the difference between the region-of-interest image P and the restored image Q (difference evaluation value calculation step S10).

Then, the foreign matter determination unit 38 redetermines whether or not the foreign matter candidate region B includes the image of the foreign matter based on the comparison between the difference evaluation value and the predetermined threshold value (foreign matter determination step S11).

Then, the display unit 45 displays the determination result by the provisional determination unit 33 or the foreign matter determination unit 38 (Step S12). That is, when the provisional determination unit 33 provisionally determines that the image of the foreign matter is not included in the foreign matter candidate region B, the display unit 45 displays information indicating that the foreign matter is not included in the inspection object 100. On the other hand, when the provisional determination unit 33 and the foreign matter determination unit 38 determine that the image of the foreign matter is included in the foreign matter candidate region B, the display unit 45 displays information indicating that the foreign matter is included in the inspection object 100.

Then, when the determination results are acquired for all of the inspection objects 100, that is, when the inspection of all of the inspection objects 100 is ended (Step S13: YES), the series of processes is ended. When the inspection of all of the inspection objects 100 is not ended (Step S13: NO), the process in Step S2 and the subsequent steps is executed again.

As described above, the foreign matter inspection device 1 according to the present embodiment restores the mask image M obtained by masking the foreign matter candidate region B in the region-of-interest image P based on the restoration algorithm and performs the foreign matter determination based on the difference between the obtained restored image Q and the original region-of-interest image P.

Therefore, the foreign matter inspection device 1 according to the present embodiment can reduce the erroneous detection of the foreign matter and inspect the foreign matter with high accuracy, as compared to a case where the foreign matter determination is performed using only the region-of-interest image P.

For example, when the foreign matter inspection device 1 according to the present embodiment performs the provisional determination using only the region-of-interest image P and then performs the redetermination using the difference image between the region-of-interest image P and the restored image Q, it is possible to double-check the inspection and to improve the inspection performance.

In addition, in the foreign matter inspection device 1 according to the present embodiment, the difference evaluation value obtained from the positive difference δ between the density values is set to be larger than the difference evaluation value obtained from the negative difference δ between the density values having the same absolute value. Therefore, when the inspection image A is the X-ray absorption image, it is possible to accurately detect the foreign matter having a positive difference between the density values of the region-of-interest image P and the restored image Q.

Further, in the foreign matter inspection device 1 according to the present embodiment, the difference evaluation value obtained from the positive difference δ between the density values is set to be smaller than the difference evaluation value obtained from the negative difference δ between the density values having the same absolute value. Therefore, when the inspection image A is the X-ray absorption image, it is possible to accurately detect the foreign matter having a negative difference between the density values of the region-of-interest image P and the restored image Q.

Furthermore, in the foreign matter inspection device 1 according to the present embodiment, the difference evaluation value obtained from the negative difference δ between the brightness values is set to be larger than the difference evaluation value obtained from the positive difference δ between the brightness values having the same absolute value. Therefore, when the inspection image A is the X-ray transmission image, it is possible to accurately detect the foreign matter having a negative difference between the brightness values of the region-of-interest image P and the restored image Q.

Moreover, in the foreign matter inspection device 1 according to the present embodiment, the difference evaluation value obtained from the negative difference δ between the brightness values is set to be smaller than the difference evaluation value obtained from the positive difference δ between the brightness values having the same absolute value. Therefore, when the inspection image A is the X-ray transmission image, it is possible to accurately detect the foreign matter having a positive difference between the brightness values of the region-of-interest image P and the restored image Q.

### DESCRIPTION OF REFERENCE NUMERALS AND SIGNS

1: foreign matter inspection device
20: X-ray inspection unit
31: inspection image generation unit
32: foreign matter candidate region specification unit
33: provisional determination unit
34: region-of-interest setting unit
35: mask image generation unit
36: restored image generation unit
37: difference evaluation value calculation unit
38: foreign matter determination unit
39: storage unit
45: display unit
46: operation unit
50: control unit
100: inspection object
A: inspection image (original image)
B, B1, B2: foreign matter candidate region
M: mask image
P, P1, P2: region of interest (region-of-interest image)
Q: restored image
W: image of inspection object

What is claimed is:

1. A foreign matter inspection device that detects a foreign matter included in an inspection object based on an image, the foreign matter inspection device comprising:
a region-of-interest setting unit that sets a region of interest including a foreign matter candidate region, which is likely to include an image of the foreign matter in the inspection object, in an inspection image in which the foreign matter candidate region has been specified;
a mask image generation unit that generates a mask image obtained by masking the foreign matter candidate region in an image of the region of interest;
a restored image generation unit that generates a restored image from the mask image based on a restoration algorithm of a model obtained by learning a good product image of the inspection object;
a difference evaluation value calculation unit that calculates a difference evaluation value for evaluating a difference between the image of the region of interest and the restored image; and
a foreign matter determination unit that determines whether or not the foreign matter candidate region includes the image of the foreign matter based on a comparison between the difference evaluation value and a predetermined threshold value.

2. The foreign matter inspection device according to claim 1,
wherein the inspection image is an X-ray absorption image obtained by converting an amount of X-rays transmitted through the inspection object into a density value proportional to a thickness of the inspection object,
the difference evaluation value is a value based on a difference between density values of the image of the region of interest and the restored image, and
when an absolute value of a positive difference between density values is equal to an absolute value of a negative difference between density values, the difference evaluation value obtained from the positive difference between the density values is different from the difference evaluation value obtained from the negative difference between the density values.

3. The foreign matter inspection device according to claim 1,
wherein the inspection image is an X-ray transmission image obtained by converting an amount of X-rays transmitted through the inspection object into a brightness value,
the difference evaluation value is a value based on a difference between brightness values of the image of the region of interest and the restored image, and
when an absolute value of a positive difference between brightness values is equal to an absolute value of a negative difference between brightness values, the difference evaluation value obtained from the negative difference between the brightness values is different from the difference evaluation value obtained from the positive difference between the brightness values.

4. The foreign matter inspection device according to claim 1, further comprising:
a foreign matter candidate region specification unit that specifies the foreign matter candidate region in the inspection image.

5. The foreign matter inspection device according to claim 2, further comprising:
a foreign matter candidate region specification unit that specifies the foreign matter candidate region in the inspection image.

6. The foreign matter inspection device according to claim 3, further comprising:
a foreign matter candidate region specification unit that specifies the foreign matter candidate region in the inspection image.

7. A foreign matter inspection method for detecting a foreign matter included in an inspection object based on an image, the foreign matter inspection method comprising:
a region-of-interest setting step of setting a region of interest including a foreign matter candidate region, which is likely to include an image of the foreign matter in the inspection object, in an inspection image in which the foreign matter candidate region has been specified;
a mask image generation step of generating a mask image obtained by masking the foreign matter candidate region in an image of the region of interest;
a restored image generation step of generating a restored image from the mask image based on a restoration algorithm of a model obtained by learning a good product image of the inspection object;
a difference evaluation value calculation step of calculating a difference evaluation value for evaluating a difference between the image of the region of interest and the restored image; and
a foreign matter determination step of determining whether or not the foreign matter candidate region includes the image of the foreign matter based on a comparison between the difference evaluation value and a predetermined threshold value.

8. The foreign matter inspection method according to claim 7,
wherein the inspection image is an X-ray absorption image obtained by converting an amount of X-rays transmitted through the inspection object into a density value proportional to a thickness of the inspection object,
the difference evaluation value is a value based on a difference between density values of the image of the region of interest and the restored image, and
when an absolute value of a positive difference between density values is equal to an absolute value of a negative difference between density values, the difference evaluation value obtained from the positive difference between the density values is different from the difference evaluation value obtained from the negative difference between the density values.

9. The foreign matter inspection method according to claim 7,
wherein the inspection image is an X-ray transmission image obtained by converting an amount of X-rays transmitted through the inspection object into a brightness value,
the difference evaluation value is a value based on a difference between brightness values of the image of the region of interest and the restored image, and
when an absolute value of a positive difference between brightness values is equal to an absolute value of a negative difference between brightness values, the difference evaluation value obtained from the negative difference between the brightness values is different from the difference evaluation value obtained from the positive difference between the brightness values.

10. The foreign matter inspection method according to claim 7, further comprising:
a foreign matter candidate region specification step of specifying the foreign matter candidate region in the inspection image.
